(19) United States
(12) Patent Application Publication
(10) Pub. No.: US 2026/0079479 A1
(43) Pub. Date: Mar. 19, 2026

(54) GENERATING ACTION OUTPUT BASED ON PROCESSING BOTH VISION DATA AND NON-VISUALLY DETECTED EVENT DATA

(71) Applicant: GDM Holding LLC, Mountain View, CA (US)

(72) Inventors: Qiao Liang, Santa Clara, CA (US); Chen Wang, Santa Clara, CA (US)

(21) Appl. No.: 19/310,542

(22) Filed: Aug. 26, 2025

Related U.S. Application Data
(60) Provisional application No. 63/694,871, filed on Sep. 15, 2024.

(51) Int. Cl. G05B 19/42; B25J 9/16; G06V 20/40; G06V 40/20

(52) U.S. Cl. CPC G05B 19/42; B25J 9/1697; G06V 20/44; G06V 40/28

(57) ABSTRACT

Generating output that is based on a sequence of actions performed by an entity and related to object(s) in an environment—and generating the output using both vision data that visually captures the entity performing the sequence of actions and event data that captures non-visually detected events that occurred in the environment during performance of the sequence of actions. Implementations utilize chain-of-modality techniques to process multiple modalities of data, each capturing corresponding aspects of the entity performing the sequence of actions, to generate output that reflects the sequence of actions. As opposed to incorporating all of multiple modalities of data in a single prompt, implementations of the chain-of-modality techniques generate and process multiple prompts in sequence, where each prompt includes only a subset of the multiple modalities of data and, when preceded by prior processing of a prior prompt, at least some of the output from the prior processing.

### BACKGROUND

Various techniques have been explored for processing vision data that captures performance of task(s) to automatically generate, based on the processing, output that reflects one or more features of the task(s) being performed.

For example, techniques have been explored for processing video to generate output that includes description(s) of task(s) being performed in the video. As another example, demonstration-based imitation learning techniques have been explored. Generally, with demonstration-based imitation learning techniques, a provided demonstration of a task can be processed to generate output that enables replication, by a non-human agent (e.g., by a physical robot) of the task of the provided demonstration. For instance, the output can reflect code and/or application programming interface (API) call(s) that can be executed to replicate the task. The provided demonstration, captured by a video, can be provided by one or more humans and/or by other autonomous non-human agents (e.g., physical robot(s)).

As one particular example, video, that captures a human interacting with object(s), can be processed in an attempt to translate the human interactions of the video to corresponding robot command(s) that, if implemented by a robot, would enable replication of the interaction.

However, for various tasks, relying solely on video and/or other visual modality, can result in ineffective translation of the tasks to output. The ineffective translation can result in output that fails to enable any replication, or fails to enable robust replication (e.g., fails in various environments), of the various tasks.

As one example, for a human demonstration of a task of wiping a whiteboard with an eraser, visual modalities may not reflect that the human is, during certain times, applying pressure on the eraser toward the whiteboard. As another example, for a human demonstration of a task of inserting a charging block into a socket, visual modalities may not reflect that an initial step of grasping the charging block is performed with low force to enable adjustment of the plug within the human's hand, whereas a following step of inserting the charging block into the socket is performed with a higher force grasp to prevent the charging block from slipping during insertion. As yet another example, for a task of using a spoon to separate the mesocarp of an avocado pericarp from the avocado exocarp, visual modalities may not reflect whether force is being applied to the exocarp in doing so.

### SUMMARY

In view of the preceding and/or other considerations, implementations disclosed herein are directed to generating output that is based on a sequence of actions performed by an entity and related to object(s) in an environment—and generating the output using both (i) vision data that visually captures the entity performing the sequence of actions and (ii) event data that captures non-visually detected events that occurred in the environment during performance of the sequence of actions by the entity. For example, the event data can reflect force data captured by electromyography (EMG) sensor(s) worn by the entity, can reflect audio data captured by transducer(s) in the environment and/or worn by the entity, can reflect accelerometer data captured by accelerometer(s) worn by the entity and/or incorporated in the object(s), and/or can reflect other data that is detected via non-visual sensor(s).

One approach to generate output using both (i) vision data and (ii) event data is to generate a single prompt that includes both (i) the vision data and (ii) the event data (optionally along with few shot example(s) and/or additional instruction(s)), and process the single prompt, using a vision-language model (VLM) or other generative model, to generate the output. For example, a single prompt can be generated that is of the form “generate output that describes actions performed by the human, and timing of those actions, given the following video that captures the human performing the actions and given the following visual representation of force data captured by EMG sensors worn by the human while performing the actions: [video]; [force data]”. Further, the single prompt can be processed using a VLM or other generative model to generate output with the intent that such output accurately reflects actions performed by the human and timing of those actions.

However, implementations disclosed herein recognize that such an approach will, for many tasks and/or for many utilized generative models, result in ineffective translation of the tasks to the output generated utilizing the generative models. For example, the output can fail to appropriately take into account all or portions of event data, can fail to synchronize the timing of event data events to corresponding vision data, and/or otherwise ineffectively translate a task, that is collectively captured by the event data and vision data, to output. This can be due to, for example, limitations of the generative model that is utilized in processing the single prompt. For example, the limitations can be due to inherent constraints of the generative model (e.g., quantity of parameters) and/or due to training of the generative model (e.g., limited or no training of the generative model on similar prompts). More generally, implementations disclosed herein recognize technical constraints with VLMs and/or other generative models, and seek to work within such constraints in translating demonstrations to actionable output.

Accordingly, implementations disclosed herein utilize chain-of-modality techniques to process multiple modalities of data, each capturing corresponding aspects of an entity (e.g., a human) performing a sequence of actions related to object(s), to generate output that accurately and comprehensively reflects the sequence of actions that are performed by the entity. As opposed to incorporating all of multiple modalities of data in a single prompt and processing the single prompt, implementations of the chain-of-modality techniques generate and process multiple prompts in sequence, where each prompt includes only a subset of the multiple modalities of data and, when preceded by prior processing of a prior prompt, at least some of the output from the prior processing.

As one example, assume (i) vision data that visually captures a human performing a sequence of actions related to object(s) in an environment with the entity and (ii) event data that captures non-visually detected events that occurred in the environment during performance of the sequence of actions by the entity.

An event data prompt can be generated that includes the event data and that optionally includes instruction(s) to generate event data output that describes non-visually detected events and corresponding timestamps for non-visually detected events reflected by the event data and/or that includes few shot example(s) of corresponding event data prompt/event data output pair(s). The event data prompt can be processed, using a VLM, to generate event data output that describes the non-visually detected events and corresponding timestamps for the non-visually detected events reflected by the event data.

A vision data prompt can subsequently be generated that includes the vision data, includes event content that is based on the event data output, and that optionally includes instruction(s) to generate vision data output and/or that includes few shot example(s) of corresponding vision data prompt/vision data output pair(s). The event content of the vision data prompt can strictly conform to the event data output, include only a subset of the event data output, or can be based on output generated based on processing an additional prompt (e.g., a pose data prompt), where the additional prompt included at least some of the event data output. The vision data prompt can be processed, using a VLM, to generate vision data output that describes at least some of the non-visually detected events, at least some of the corresponding timestamps for the non-visually detected events, and object(s) of the environment to which the sequence of actions are related.

With such an example, it is noted that the vision data output describes non-visually detected event(s), and timestamp(s) thereof, as a result of the vision data prompt including the event content that is based on the previously generated event data output. Moreover, the vision data output describes object(s) of the environment as a result of the vision data prompt including the vision data that captures those object(s)—whereas the event data may not capture any aspects of those object(s).

The generated vision data output can be used for various purposes. For example, the vision data output can be used to generate an action prompt that includes the vision data output, the action prompt processed to generate action output that reflects one or more automated actions to perform based on the vision data output, and the action output used to cause implementation of the one or more automated actions. As one particular example, the action prompt can include instructions and/or few shot example(s) for generating a sequence of robot actions that are based one the vision data output, the automated actions of the action output can be a sequence of robot actions, and the sequence of robot actions provided to real and/or simulated robot(s) to cause implementation thereof by the robot(s). For instance, implementation of the sequence of robot actions can result in replication of the task(s) captured by the vision data and the event data. As another particular example, the action prompt can include instructions and/or few shot example(s) for generating automated assistant action(s) that are based on the vision data output, the automated action(s) of the action output can be automated assistant action(s), and the automated assistant action(s) can be caused to be implemented. For instance, if the vision data output reflects that the human is preparing a duck for roasting, the automated assistant action(s) can include pre-heating of a smart oven to a temperature appropriate for roasting duck, rendering of visual and/or audible output that describes a duration and/or temperature appropriate for roasting duck, and/or other automated assistant action(s).

As another example, assume (i) a sequence of vision data that visually captures a human performing a sequence of actions related to object(s) in an environment with the human, (ii) a sequence of pose data that captures pose information for one or both hands of the human during the sequence of actions, and (iii) event data that captures non-visually detected forces (e.g., detected via EMG sensor(s)) that were applied by the hand(s) and/or arm(s) of the human during performance of the sequence of actions by the human.

An event data prompt can be generated that includes the event data that captures the forces and that optionally includes instruction(s) to generate event data output and/or that includes few shot example(s) of corresponding event data prompt/event data output pair(s). The event data prompt can be processed, using a VLM, to generate event data output.

A pose data prompt can then be generated that includes the sequence of pose data, the event data output, and, optionally, instruction(s) to generate pose data output and/or that includes few shot example(s) of corresponding pose data prompt/pose data output pair(s). The pose data prompt can be processed, using a VLM, to generate pose data output.

A vision data prompt can then be generated that includes the sequence of vision data, includes the pose data output, and that optionally includes instruction(s) to generate vision data output and/or that includes few shot example(s) of corresponding vision data prompt/vision data output pair(s). The vision data prompt can be processed, using a VLM, to generate vision data output. In various implementations, the vision data output can include natural language content, such as natural language content that describes at least some of the non-visually detected forces, at least some of the corresponding timestamps for the non-visually detected forces, and the object(s) in the environment. For example, the vision data output can include only natural language content in some of those various implementations.

The vision data output can be used to generate an action prompt that includes the vision data output, the action prompt processed to generate action output that reflects one or more automated actions to perform based on the action prompt, and the action output used to cause implementation of the one or more automated actions.

In some implementations, data from the chain-of-modality prompting can be utilized to generate corresponding training instances that can be used to fine-tune a VLM for multi-modal single prompt processing, and such a fine-tuned VLM then used for multi-modal single prompt processing in lieu of the chain-of-modality prompting. Put another way, in some implementations such corresponding training instances can be used to fine-tune a VLM or other generative model to mitigate training-based constraints of the VLM.

As one example, a training instance can be generated that includes training instance input that includes a multimodal prompt with multiple modalities of data (e.g., vision data and event data) used in prior chain-of-modality prompting. Further, the training instance can include training instance output that is based on output from a final iteration of the chain-of-modality prompting, such as training instance output that conforms to action output of the prior chain-of-modality prompting.

Some implementations described herein relate to visually prompting a VLM or another generative model to generate, based on a provided demonstration, automated actions performed by a physical robot. In various implementations, forces applied by a force-applying entity while performing action(s) can be collected, along with visual representations (e.g., a video) capturing the force-applying entity in performing the action(s), to generate a multi-modal representation. In various implementations, the multi-modal representation can further include pose information of the force-applying entity while performing the action(s). A Chain-of Modality (COM) framework can be applied to assemble VLM input prompts based on the multi-modal representations. The VLM input prompts are processed (e.g., iteratively), using a VLM to generate a final VLM output. Based on the final VLM output, a robot can be controlled to replicate the action(s) performed by the force-applying entity and captured in the visual representations.

Some implementations disclosed herein can include one or more transitory and/or non-transitory computer readable storage media storing instructions executable by a processor (e.g., central processing unit, graphical processor unit, tensor processing unit) to perform a method such as one or more of the methods described herein. Some implementations disclosed herein can include a system including memory and one or more processors operable to execute instructions, stored in the memory, to implement one or more modules or engines that, alone or collectively, perform a method such as one or more of the methods described herein.

### BRIEF DESCRIPTION OF THE DRAWINGS

FIG. 1 schematically depicts an example environment in which disclosed techniques can be employed, in accordance with various implementations.

FIG. 2 depicts an example robot, in accordance with various implementations.

FIG. 3A and FIG. 3B depict a non-limiting example of how techniques described herein can be applied in accordance with various implementations.

FIG. 4A and FIG. 4B depict robot(s) replicating motions learned from videos to carry out selected aspects of the present disclosure, in accordance with various implementations.

FIG. 5 is a flowchart illustrating an example process 500 for generating and using a single prompt that includes multiple data modalities to generate an action output, in accordance with various implementations.

FIG. 6 is a flowchart illustrating an example process 600 for generating an action output based on iteratively processing multiple data modalities, in accordance with various implementations.

### DETAILED DESCRIPTION

In various implementations, a multi-model representation is generated and processed using Chain-of Modality (COM) framework that iteratively introduces each modality from the multi-modal representation.

For example, a temporal sequence of forces applied by a force-applying entity while performing action(s) can be collected, along with visual representations (e.g., a video, or a temporal sequence of images) capturing the force-applying entity in performing the action(s). The action(s) can be one or more actions requiring precise control or application of forces to manipulate an object, such as grasp lightly to rotate a first object in-hand, push harder to insert a second object, etc. The multi-modal representation can include representations having different modalities. For example, the multi-modal representation can include both a video (or other visual representation) capturing motions of a force-applying entity in manipulating an object and a temporal sequence of forces (e.g., showing a force intensity of a force varying with progression of time) the force-applying entity applies in manipulating the object. In some of the various implementations, additionally, or alternatively, the multi-modal representation can include pose information of the force-applying entity in manipulating the object. While some examples or implementations described herein relate to generating action output that can be used to control a real physical robot, this is not meant to be limiting. Techniques described herein can be applicable in various contexts and alternative action output can be generated, such as alternative action output that can be used to perform automated assistant action(s).

In some implementations, a multi-model representation can include a first video capturing a first set of motions of a first force-applying entity and a temporal sequence of forces corresponding to the first video (e.g., that were applied by the first force-applying entity during the first set of motions). In this example, the CoM framework can include processing the temporal sequence of forces as input (e.g., processing a graphical representation of the temporal sequences of forces), using the VLM, to generate a first model output reflecting a force-change representation that indicates detection of one or more force-changing events (e.g., one or more timestamps at which force application or release is detected and/or force information indicating an amount of the force applied at the timestamp(s)). The force-change representation and the first video capturing the first set of motions of the first force-applying entity can be processed as input, using the VLM, to generate output reflecting a plurality of actions extracted from the motions in the video, action parameters associated with the plurality of actions, and/or force information (force applying, force releasing, and/or specific amount of force applied, etc.) associated with one or more actions of the plurality of actions.

In the preceding example, the output can be processed to generate a robot-executable script (e.g., in python language or other applicable language, may also be referred to as the “robot control code” or “robot control data”). Using the generated robot control data, a robot can be controlled to replicate the first set of motions performed by the first force-applying entity, e.g., in manipulating an object.

As another example, a multi-model representation can include a second video capturing a second set of motions of a second force-applying entity, pose information of the second force-applying entity during the second set of motions, and a temporal sequence of forces corresponding to the second video. In this example, the CoM framework can include processing the temporal sequence of forces as input, using the VLM, to generate a first model output reflecting a force-change representation that indicates detection of one or more force-changing events (e.g., one or more timestamps at which force application or release is detected and/or force information indicating an amount of the force applied at the timestamp(s)). The force-change representation and the pose information of the second force-applying entity during the second set of motions can be processed as input, using the VLM, to generate a second model output reflecting an action representation that includes a plurality of actions determined from the second set of motions, and/or force information associated with one or more actions of the plurality of actions.

Continuing with the example, the action representation that includes the plurality of actions determined from the second set of motions (and/or force information associated with one or more actions of the plurality of actions) and the second video capturing the second set of motions of the second force-applying entity can be processed as input, using the VLM, to generate a further output reflecting an action parameter representation that includes the plurality of actions extracted from the motions in the second video, action parameters associated with the plurality of actions, and/or the force information (force applying, force releasing, and/or specific amount of force applied, etc.) associated with one or more actions of the plurality of actions. The further output can be processed to generate a robot-executable script. Using the generated robot control data, a robot can be controlled to replicate the first set of motions performed by the first force-applying entity, e.g., in manipulating an object.

Techniques described herein can give rise to various technical advantages. For example, robot control policies or robot control data can be generated based on learning from a video capturing motions of an entity in performing a basic task (e.g., pick up a pencil) requiring no awareness of specific forces applied. Conventional learning from the video alone, however, may not be applicable to generate robot control data for controlling a robot to replicate motions (e.g., of a human hand) in performing force-aware tasks (e.g., push hard to insert a plug into a socket, etc.) that require precise control and/or application of force(s). By generating a multi-modal representation that includes different modalities of representations (e.g., force intensity, pose information, and visual representation) and by utilizing the CoM framework and a VLM in processing the multi-modal representations, the multi-modal representation can be processed iteratively, to generate action output, such as action output that enables a robot to replicate human motions (or motions of other entities) captured in the visual representation (e.g., a video or a temporal sequence of images), even if such human motions require sophisticated application of forces.

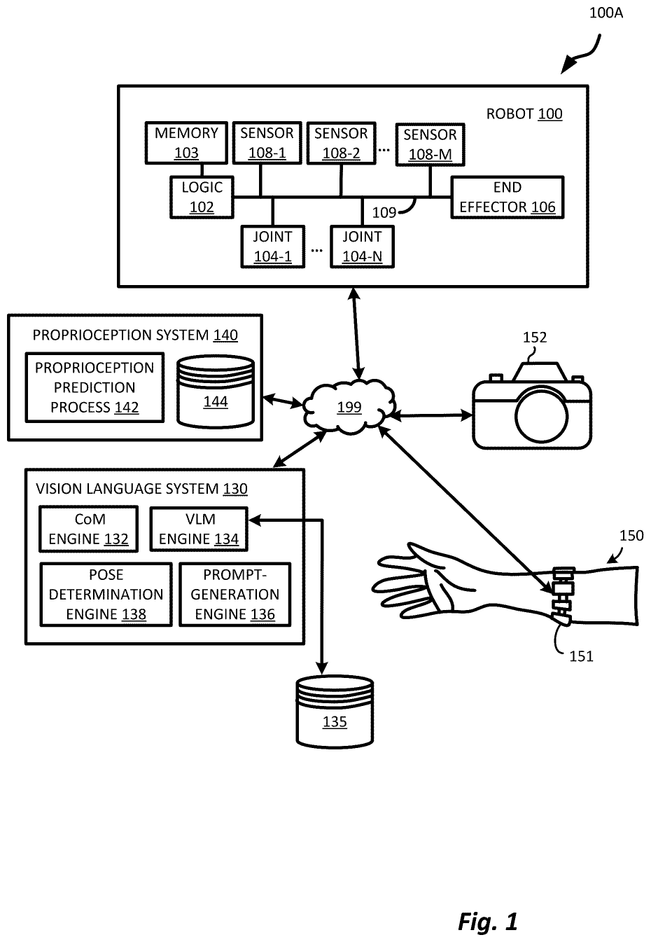

FIG. 1 is a schematic diagram illustrating component(s) that can cooperate to carry out selected aspects of the present disclosure, in accordance with various implementations. The various components depicted in FIG. 1 can be implemented using any combination of hardware and software. The components of FIG. 1 are depicted as being communicatively coupled with each other via one or more networks 199, which can include one or more personal area networks, local area networks, and/or wide area networks (e.g., the Internet). However, this is not meant to be limiting. Various aspects of the present disclosure that are described as being performed by and/or stored on systems 130 and/or 140 can alternatively be performed by and/or stored on a single system, such as a vision language system 130, or on any combinations of systems 130 and 140.

In some implementations, techniques described herein can be used to control various types of machines or apparatus, such as robot(s) and/or automated assistant device(s). For example, in some implementations, a robot 100 can be in communication with systems 130 and/or 140. In various implementations, all or parts of systems 130 and/or 140 can be implemented onboard the robot 100. Other types of machines or apparatus that are not depicted in FIG. 1 can also be controlled using selected aspects of the present disclosure, such as autonomous vehicles, industrial equipment, climate control systems, medical systems, automated assistant devices, gaming devices, and/or other devices.

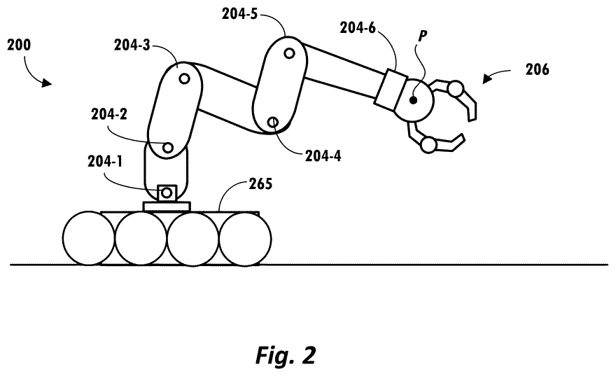

Robot 100 can take various forms, including but not limited to a telepresence robot (e.g., which may be as simple as a wheeled vehicle equipped with a display and a camera), a robot arm, a multi-pedal robot such as a “robot dog,” an aquatic robot, a wheeled device, a submersible vehicle, an unmanned aerial vehicle (“UAV”), and so forth. One non-limiting example of a mobile robot arm is depicted in FIG. 2. In various implementations, robot 100 can include logic 102. Logic 102 may take various forms, such as a real time controller, one or more processors, one or more field-programmable gate arrays (“FPGA”), one or more application-specific integrated circuits (“ASIC”), and so forth. In some implementations, logic 102 can be operably coupled with memory 103. Memory 103 can take various forms, such as random-access memory (“RAM”), dynamic RAM (“DRAM”), read-only memory (“ROM”), Magnetoresistive RAM (“MRAM”), resistive RAM (“RRAM”), NAND flash memory, and so forth. In some implementations, a robot controller can include, for instance, logic 102 (e.g., one or more processor(s)) and memory 103 of robot 100.

In some implementations, logic 102 can be operably coupled with one or more joints 104-1 to 104-N, one or more end effectors 106, and/or one or more sensors 108-1 to 108-M, e.g., via one or more buses 109. As used herein, “joint” 104 of a robot can broadly refer to actuators, motors (e.g., servo motors), shafts, gear trains, pumps (e.g., air or liquid), pistons, drives, propellers, flaps, rotors, or other components that may create and/or undergo propulsion, rotation, and/or motion. Some joints 104 can be independently controllable, although this is not required. In some instances, the more joints robot 100 has, the more degrees of freedom of movement robot 100 may have.

As used herein, “end effector” 106 can refer to a variety of tools that may be operated by robot 100 in order to accomplish various tasks. For example, some robots can be equipped with an end effector 106 that takes the form of a claw with two opposing “fingers” or “digits.” Such a claw is one type of “gripper” known as an “impactive” gripper. Other types of grippers can include but are not limited to “ingressive” (e.g., physically penetrating an object using pins, needles, etc.), “astrictive” (e.g., using suction or vacuum to pick up an object), or “contigutive” (e.g., using surface tension, freezing or adhesive to pick up object). More generally, other types of end effectors can include but are not limited to drills, brushes, force-torque sensors, cutting tools, deburring tools, welding torches, containers, trays, and so forth. In some implementations, end effector 106 can be removable, and various types of modular end effectors may be installed onto robot 100, depending on the circumstances. Some robots, such as a telepresence robot, may not be equipped with end effectors. Instead, a telepresence robot can include displays to render visual representations of the users controlling the telepresence robots, as well as speakers and/or microphones that facilitate the telepresence robot “acting” like the user.

Sensors 108-1 to 108-M can take various forms, including but not limited to 3D laser scanners (e.g., light detection and ranging, or “LIDAR”) or other 3D vision sensors (e.g., stereographic cameras used to perform stereo visual odometry) configured to provide depth measurements, two-dimensional cameras (e.g., RGB, infrared), light sensors (e.g., passive infrared), force sensors, pressure sensors, pressure wave sensors (e.g., microphones), proximity sensors (also referred to as “distance sensors”), depth sensors, torque sensors, barcode readers, radio frequency identification (“RFID”) readers, radars, range finders, accelerometers, gyroscopes, compasses, position coordinate sensors (e.g., global positioning system, or “GPS”), speedometers, edge detectors, Geiger counters, and so forth. While sensors 108-1 to 108-M are depicted as being integral with robot 100, this is not meant to be limiting. For example, one or more of sensors 108-1 to 108-M can be external to and/or coupled with robot 110.

In some implementations, vision language system 130 and/or proprioception system 140 can include one or more computing devices cooperating to perform selected aspects of the present disclosure. In some implementations, one or more of systems 130 and/or 140 can include one or more servers forming part of what is often referred to as a “cloud” infrastructure, or simply “the cloud.” Alternatively, one or more components of systems 130 and/or 140 may be operated by logic 102 of robot 100.

Machine learning model(s) described herein can take various forms, including, but not limited to, generative language model(s) (sometimes referred to as “large language models,” or “LLMs”) such as PaLM, BERT, LaMDA, Meena, and/or any other generative language model, such as any other generative model that is encoder-only based, decoder-only based, sequence-to-sequence based and that optionally includes an attention mechanism or other memory. In generative model form, machine learning model(s) can have hundreds of millions, or even hundreds of billions of parameters. In some implementations, machine learning model(s) can include a multi-modal model such as a VLM and/or a visual question answering (VQA) model, which can have any of the aforementioned (or other) architectures, and which can be used to process multiple modalities of data, such as images and text, and/or images and audio for example, to generate one or more modalities of output. Non-limiting examples of VLMs that can be applied as described herein include Gemini and/or Flamingo, to name a few.

Vision language system 130 may include a Chain-of-Modality (COM) engine 132, a VLM engine 134, one or more VLMs 135, a prompt-generation engine 136, and a pose determination engine 138. Any of engines 132, 134, 136, and/or 138 may be implemented using any combination of hardware and software. Moreover, any of engines 132, 134, 136, and/or 138 may be combined with other(s) of engines 132, 134, 136, and/or 138.

In various implementations, a Chain-of Modality (COM) engine 132 can be configured to receive a sequence (e.g., temporal sequence) of event data, such as but not limited to, operation forces applied by a force-applying entity (e.g., 150) while performing an action (e.g., push, or a sequence of actions such as grasp and twist) with respect to an object. In various implementations, CoM engine 132 can be additionally or alternatively configured to receive a video capturing the force-applying entity while the force-applying entity is performing the action (or the sequence of actions) with respect to the object. In some implementations, COM engine 132 can synchronize the sequence of operation forces applied by the force-applying entity while performing the action (or the sequence of actions) with the video capturing the force-applying entity while the force-applying entity is performing the action (or the sequence of actions) with respect to the object.

In some implementations, the pose determination engine 138 can determine a pose of the force-applying entity (e.g., 150) from an image capturing the force-applying entity. The pose of the force-applying entity can include, for instance, locations (e.g., pixel locations) for one or more portions of the force-applying entity in the image. For example, when the force-applying entity is a human hand, the image capturing the human hand can be processed, e.g., using one or more machine learning (ML) models, to generate a ML model output reflecting a pose of the human hand. For instance, the pose of the human hand can include pixel locations of one or more fingertips (e.g., each fingertip) of the human hand. A sequence of images (e.g., a sequence of images of video) can be processed to generate a sequence of poses of the force-applying entity.

Proprioception system 140 can be present in some implementations. Proprioception system 140 can be omitted in other implementations. Proprioception system 140 can include a proprioception prediction engine 142 and one or more proprioception machine learning models 144.

In various implementations, proprioception prediction engine 142 can process input tokens indicative of a current (or past) proprioception values of robot 100, e.g., along with other data such as data indicative of a task or action to be performed (e.g., an action sampled or determined, and selected as described herein), state data of the robot's environment, etc., to generate robot control data and/or predict future proprioception values of robot 100. These robot control data and/or future proprioception values can be used to operate robot 100. “Robot control data” may include, for instance, low-level actuator commands (also referred to as “joint commands,” and may include torque commands) that directly control the actuators/joints 104-1 to 104-N of the robot, cartesian commands that specify direction(s) for an end effector 106, a target robot pose, code that specifies reward functions that a motion controller can optimize (e.g., using techniques such as receding horizon optimization) to find optimal low-level actuator commands, selected predefined robot primitives, and so forth. In some cases, robot logic 102 can be configured to convert between joint commands and Cartesian commands, e.g., using forward and/or inverse kinematics.

In various implementations, a force-applying entity 150 (e.g., human hand or other force-applying entity) can apply a sequence of forces to perform one or more actions (e.g., grasp a bottle), and a force-collecting sensor 151 can be used to collect the sequence of forces while the force-applying entity 150 is performing the one or more actions. In various implementations, a vision sensor 152 (or a device having one or more vision sensors, such as a camera, a smart phone, etc.) can capture a video (or a sequence of images) that captures the force-applying entity 150 performing the one or more actions. In some implementations, the force-collecting sensor 151 can be included in a wearable device attached to the force-applying entity 150. In some implementations, the force-collecting sensor 151 can be an electromyography (EMG) sensor. The EMG sensor can be configured to detect a force signal that reflects when and how much a force is applied by the force-applying entity 150. In some implementations, the wearable device can be a smartwatch, an armband, and/or other wearable device.

In some implementations, the vision sensor 152 can be used to capture a video (e.g., a sequence of images) visually depicting manipulation action(s) being performed by the force-applying entity 150 that is coupled with the force-collecting sensor 151, where the force-collecting sensor 151 can be used to collect force signals (e.g., force intensities in the form of a sequence of signals) that reflect force(s) applied by the force-applying entity 150 in performing the manipulation action(s). In various implementations, the utilization of the force-collecting sensor 151 enables ascertaining of one or more force-aware manipulation actions (e.g., grasp lightly to rotate an object in-hand, push harder to insert an object, etc.) from processing of a multi-modal representation/demonstration (e.g., a visual representation augmented with force data/information).

As a result, when performing a manipulation task requiring precise force application such as inserting a power plug (instead of basic operations such as pick-and-place), the use of the EMG sensor (or other force-collecting sensor/device) enables detection of a change in forces (e.g., a change from a low force applied to first grasp the plug and/or adjusts an orientation of the plug, to a stronger force applied to insert the plug into a socket), which would otherwise be hard (or impossible) to detect from a video alone. The detection of the change(s) in forces can be utilized in parsing a manipulation task (e.g., power plug insertion) into one or more actions (e.g., a first action of grasping the plug, a second action of rotating the plug, and/or a third action of inserting the plug into the socket).

In various implementations, a multi-modal representation can be processed (e.g., iteratively in a CoM manner) by the CoM engine 132, using a vision-language model (VLM), to generate a VLM output from which output actions can be derived or generated, such as robot control actions (e.g., in the form of sequential force-related robot API calls). For example, given a video capturing motions of the force-applying entity 150, where the force-applying entity 150 is coupled with the force-collecting sensor 151 to collect a temporal sequence of forces applied by the force-applying entity 150 during the captured motions, the video can be correlated or associated with the temporal sequence of forces to generate the multi-modal representation. The temporal sequence of forces can be processed as input, using the VLM, to generate a first model output reflecting a force-change representation (e.g., detection of one or more force-changing events such as a first force being applied at a first timestamp and a second force being released at a second timestamp).

In some implementations, the first model output (or the force-change representation derived from the first model output) and the video (that captures the motions of the force-applying entity 150 and that temporally corresponds to the temporal sequence of forces) can be processed as input, by the CoM engine 132 and using the VLM, to generate further model output. The further model output can reflect an action parameter representation that includes a segmentation of the motions into a plurality of actions (e.g., a first action at the first timestamp, a second action between the first and second timestamps, and a third action at the second timestamp), action parameters associated with the plurality of actions, and/or force information (force applying, force releasing, and/or specific amount of force applied, etc.) associated with one or more actions of the plurality of actions.

In some implementations, the further model output can be processed to generate action output, such as action output that reflects robot control parameters (e.g., sequential API calls) that can be used to control a robot to replicate the motions captured in the video.

In some implementations, the multi-modal representation can further include pose information of the force-applying entity 150. In some of those implementations, the aforementioned first model output and the pose information of the force-applying entity 150 can be processed, as input, using the VLM, to generate a second model output. The second model output can reflect an action representation that includes a segmentation of the motions into a plurality of actions (e.g., a first action at the first timestamp, a second action between the first and second timestamps, and a third action at the second timestamp), and/or force information (force applying, force releasing, and/or specific amount of force applied, etc.) associated with one or more actions of the plurality of actions. In some implementations, the action representation may not include action parameters (e.g., an object the force-applying entity is to manipulate or has manipulated) associated with the plurality of actions.

The second model output and the video (that captures the motions of the force-applying entity 150 and that temporally corresponds to the temporal sequence of forces) may be processed as input, by the CoM engine 132 and using the VLM, to generate a further model output. The further model output can reflect an action parameter representation that includes not only the plurality of actions (e.g., the aforementioned first action at the first timestamp, the second action between the first and second timestamps, and the third action at the second timestamp) and/or force information (force applying, force releasing, and/or specific amount of force applied, etc.) associated with one or more actions of the plurality of actions, but also action parameters associated with the plurality of actions.

FIG. 2 depicts a non-limiting example of a robot 200 in the form of a robot arm. An end effector 206 in the form of a gripper claw is removably attached to a sixth joint 204-6 of robot 200. In this example, six joints (e.g., 204-1, 204-2, 204-3, 204-4, 204-5, 204-6) are indicated. However, this is not meant to be limiting, and robots may have any number of joints. In some implementations, robot 200 may be mobile, e.g., by virtue of a wheeled base 265 or other locomotive mechanism. Robot 200 is depicted in FIG. 2 in a particular selected configuration or “pose.”

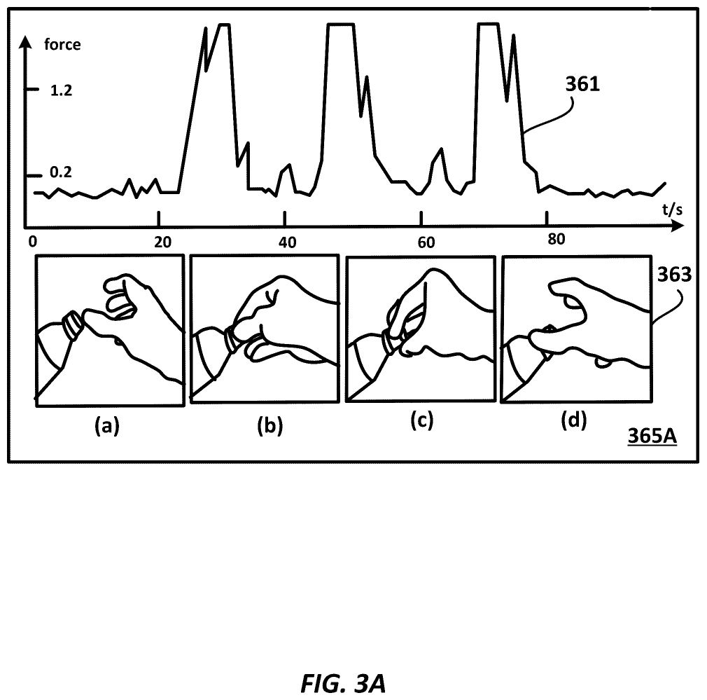

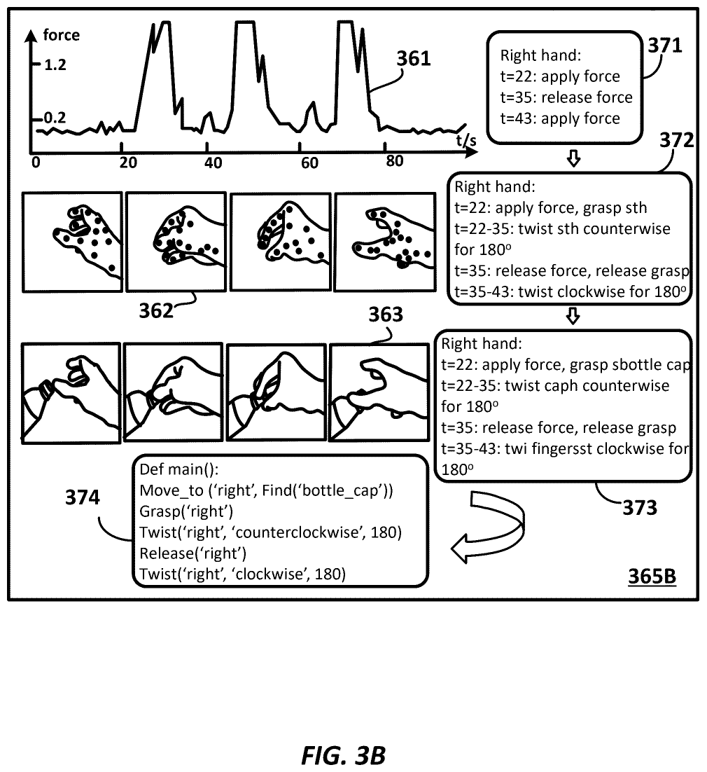

FIGS. 3A and 3B depict a non-limiting example of how techniques described herein (e.g., COM, etc.) may be applied for a robot to replicate object manipulation requiring precise force application (e.g., grasp to open and close a water bottle), from a single-shot human demonstration using video and force data collected in association with the video. As shown in FIG. 3A, multi-modal data collected from a force-applying entity (e.g., a right hand) during motions of the force-applying entity to manipulate a force-aware task (e.g., to manipulate a bottle to open and close a cap of the bottle) can be illustrated using a first representation 365A.

The multi-modal data in the first representation 365A can include a temporal sequence of forces 361 (e.g., in a form of an image of a graph that reflects magnitude of the forces over time) that reflects forces applied by the force-applying entity during motions of the force-applying entity in manipulating the bottle. The multi-modal data in the first representation 365A can further include a video 363 (or a portion thereof) capturing the motions of the force-applying entity in manipulating the bottle. In some implementations, timestamps of the video 363 capturing the motions of the force-applying entity in manipulating the bottle can correspond to (e.g., one-on-one correspondence) timestamps in the temporal sequence of forces 361.

In some implementations, the temporal sequence of forces 361 that reflects the forces applied by the force-applying entity during motions of the force-applying entity in manipulating the bottle can be collected using a force-collecting sensor. The forces applied by the force-applying entity can be optionally normalized to corresponding float values (e.g., 0.2, 1.2 in FIG. 3A). In some implementations, the force-collecting sensor can be included in a wearable device attached to the force-applying entity. In some implementations, the force-collecting sensor can be an electromyography (EMG) sensor. The EMG sensor can be configured to detect a force signal that reflects when and how much a force is applied by the force-applying entity. In some implementations, the wearable device can be a smartwatch, an armband, or other wearable device.

In some implementations, the video 363 (or a portion thereof) capturing the motions of the force-applying entity in manipulating the bottle can be collected using a vision sensor such as a camera (e.g., RGB camera, RGB-D camera) or other image capturing device (e.g., a smart phone, a laptop, etc.).

In some implementations, optionally, the video 363 (or a portion thereof) capturing the motions of the force-applying entity in manipulating the bottle can be processed to determine pose information (e.g., hand pose information, see “362” in FIG. 3B) of the force-applying entity (e.g., right hand) during the motions of the force-applying entity in manipulating the bottle. As a non-limiting example, the pose information can include, for instance, two-dimensional (2D) pixel locations of a thumb and a middle fingertip. Optionally, a model of the force-applying entity (e.g., a right hand model) can be reconstructed using the pose information (e.g., hand pose information) of the force-applying entity, but this is not required. Optionally, the video 363 can be processed using one or more ML models, to generate the pose information.

As a working example, a multi-modal representation can be generated based on the temporal sequence of forces 361, the video 363 temporally correlated to the temporal sequence of forces 361, and/or the pose information 362 determined from the video 363. In this working example, the temporal sequence of forces 361 (e.g., that reflects the forces applied by the force-applying entity during motions of the force-applying entity in manipulating the bottle) can be processed as input, using a VLM, to generate a first model output from which a force-change representation 371 is derived. The first model output (or the force-change representation 371) can reflect one or more key timestamps at which force application or force release is detected. For example, as shown in representation 365B of FIG. 3B, the force-change representation 371 can identify a first key timestamp (e.g., t=22 s) and detection of force application at the first key timestamp, a second key timestamp (e.g., t=35 s) and detection of force release at the second key timestamp, and a third key timestamp (e.g., t=43 s) and detection of force application at the third key timestamp. Optionally, based on metadata associated with the force-collecting sensor (e.g., the EMG sensor) that is attached to the force-applying entity, an identity (e.g., “right hand”) can be determined for the force-applying entity. The force-change representation 371 can optionally include the identity (e.g., “right hand”) of the force-applying entity.

Continuing with the working example above, the force-change representation 371 and the pose information (or reconstructed images 362 showing a model of a right hand that are augmented with pose information, e.g., pixel locations of each fingertip in the right hand) of the force-applying entity can be processed as input, using a VLM, to generate a second model output from which an action representation 372 is derived. The action representation 372 can indicate, for instance, one or more key timestamps, one or more motion stages determined based on the one or more key timestamps, an action determined/sampled for each key timestamp or motion stage, and/or force information associated with one or more actions of the plurality of actions.

As shown in FIG. 3B, a non-limiting example of the action representation 372 may be: “t=22 s: apply force, grasp something; t=22-35 s: twist something counterwise for 180 degree; t=35 s: release force, release grasp; t=35-43 s: twice clockwise for 180 degrees.” In this example, “t=22 s” is the first key timestamp, “t=35 s” is the second key timestamp, “t=22-35 s” is a first motion stage, and “t=35-43 s” is a second motion stage subsequent to the first motion stage. The first key timestamp (e.g., “t=22 s”) can be associated with detection of force application, and a first action of “grasp” may be determined for the first key timestamp. The first motion stage (e.g., “t=22-35 s”) can be associated with a second action of “twist” or “twist . . . counterwise for 180 degrees”. The second key timestamp (e.g., “t=35 s”) can be associated with detection of force release, and a third action of “release grasp” may be determined for the second key timestamp. The second motion stage (e.g., “t=35-43 s”) can be associated with a fourth action of “twist” or “twist . . . clockwise for 180 degrees”.

Continuing with the working example above, the action representation 372 and the video 363 can be processed as input, using a VLM, to generate a final model output from which an action parameter representation 373 is derived. The action parameter representation 373 can indicate, for instance, one or more key timestamps, one or more motion stages determined based on the one or more key timestamps, an action determined/sampled for each key timestamp or motion stage, action parameters determined for the action at each key timestamp or motion stage, and/or force information associated with one or more actions of the plurality of actions.

As shown in FIG. 3B, a non-limiting example of the action parameter representation 373 may be: “t=22 s: apply force, grasp bottle cap; t=22-35 s: twist cap counterwise for 180 degree; t=35 s: release force, release grasp; t=35-43 s: twist fingers clockwise for 180 degrees.” In this example, the first key timestamp (e.g., “t=22 s”) can be associated with detection of force application, a first action of “grasp”, and an action parameter of “bottle cap” determined for the first action of “grasp”. The first motion stage (e.g., “t=22-35 s”) can be associated with a second action of “twist” or “twist . . . counterwise for 180 degrees”, and an action parameter of “cap” can be determined for the second action of “twist”. The second key timestamp (e.g., “t=35 s”) can be associated with detection of force release, and a third action of “release grasp” may be determined for the second key timestamp. The second motion stage (e.g., “t=35-43 s”) can be associated with a fourth action of “twist” or “twist . . . clockwise for 180 degrees”, and action parameters of “fingers” determined for the fourth action of “twist”.

In some implementations, further referring to FIG. 3B, the final model output (or the action parameter representation 373) can be processed, e.g., based on a code generation prompt (e.g., including a statement to inform the VLM of available APIs along with the requirements of output format), to generate a robot control representation 374 using which a robot can be controlled to replicate the motions captured in the video 363. Continuing with the working example above, the robot control representation 374 can include, for instance, the following robot control code (e.g., not identifying specific force intensity):

“Def main( ):
Move_to (‘right’, Find(‘bottle_cap’)
Grasp(‘right’)
Twist(‘right’, ‘counterclockwise’, 180)
Release(‘right’)
Twist(‘right’, ‘clockwise’, 180)”,

or the following alternate robot control code (e.g., identifying specific force intensity where applicable):

“Def main( ):
Move_to (‘right’, Find(‘bottle_cap’)
Grasp(‘right’) # force range [0, 100]
Twist(‘right’, ‘counterclockwise’, 180)
Release(‘right’)
Twist(‘right’, ‘clockwise’, 180)”

In some implementations, the code generation prompt can be, for instance, “from skills import Grasp, Release, Twist, Find, Move_to # based on video analysis and APIs, generate python code”. The code generation prompt can be processed, for instance, using the VLM, to generate a robot-executable script (e.g., in python language or other applicable language, may also be referred to as the “robot control code”).

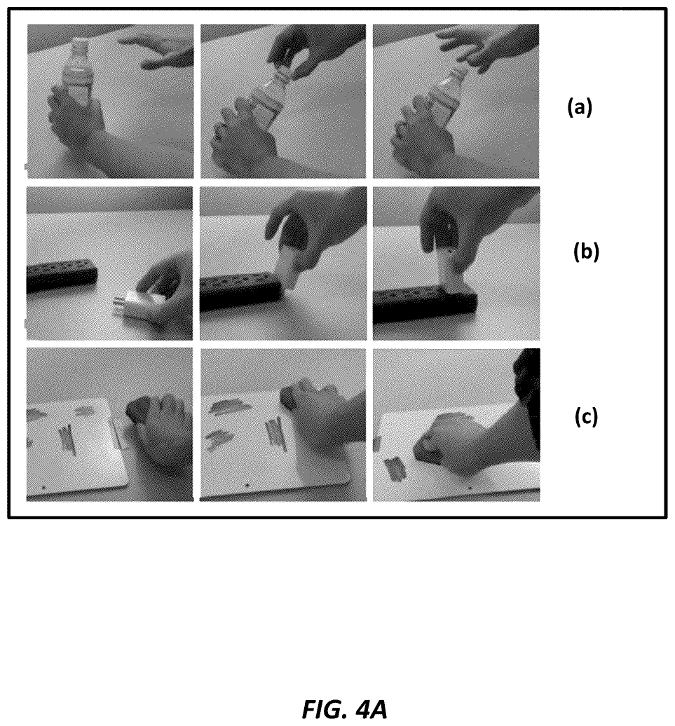

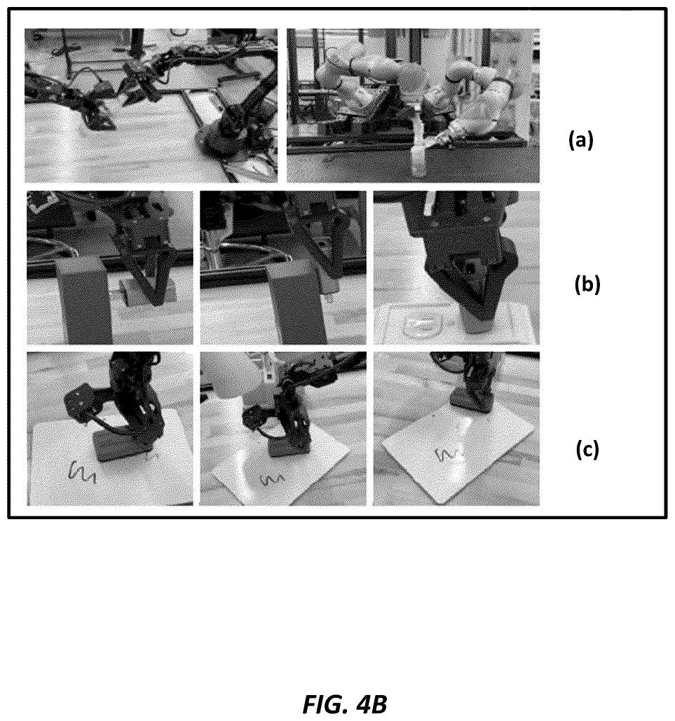

FIG. 4A and FIG. 4B depict robot(s) replicating motions learned from videos to carry out selected aspects of the present disclosure, in accordance with various implementations. As can be seen from FIG. 4A and FIG. 4B, using the CoM techniques described herein, a robot (or different robots) can learn to replicate motions captured in different videos each augmented with force intensity data collected from a force-collecting sensor attached to a force-applying entity during the motions of the force-applying entity. For example, in scenario (a) of FIG. 4A, a video capturing a human hand opening a bottle can be collected and augmented with a temporal sequence of forces applied by the human hand in opening the bottle. Using techniques described in this disclosure, a multi-modal representation can be generated to include the video (or a selected images thereof, which may be referred to as “visual representations”), the temporal sequence of forces, and/or pose information of the human hand (which is a non-limiting example of the force-applying entity). The pose information of the human hand can include, for instance, pixel locations of one or more fingers of the human hand, and can be determined based on processing the video (e.g., the visual representations). Correspondingly, in scenario (a) of FIG. 4B, two different robots are controlled using robot control data generated based on learning the augmented video (or a multi-modal representation as described previously in this disclosure) in scenario (a) of FIG. 4A, to replicate motions of the human hand in scenario (a) of FIG. 4A.

As another example, in scenario (b) of FIG. 4A, a video capturing a human hand inserting a plug into a socket can be collected and augmented with a temporal sequence of forces applied by the human hand in opening the bottle. Corresponding, in scenario (b) of FIG. 4B, a robot is controlled using robot control data generated based on learning the augmented video (or a multi-modal representation as described previously in this disclosure) in scenario (b) of FIG. 4A, to replicate motions of the human hand in scenario (b) of FIG. 4A, e.g., inserting a first plug into a first socket, and/or inserting a second plug into a second socket different from the first socket.

As a further example, in scenario (c) of FIG. 4A, a video capturing a human hand wiping a board can be collected and augmented with a temporal sequence of forces applied by the human hand in opening the bottle. Correspondingly, in scenario (c) of FIG. 4A, a robot is controlled using robot control data generated based on learning the augmented video (or a multi-modal representation as described previously in this disclosure) in scenario (c) of FIG. 4A, to replicate motions of the human hand in scenario (c) of FIG. 4A.

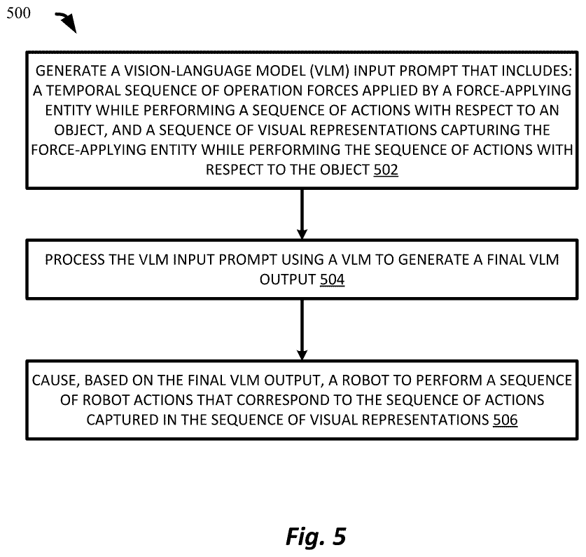

FIG. 5 is a flowchart illustrating an example process 500 for generating and using a single prompt that includes multiple data modalities to generate an action output, in accordance with various implementations. The process 500 can be performed, for example, by one or more components of FIG. 1, such as the vision language system 130.

At block 502, a vision-language model (VLM) input prompt is generated that includes a temporal sequence of operation forces and a sequence of visual representations. The temporal sequence of operation forces can be applied by a force-applying entity while performing a sequence of actions with respect to an object. The sequence of visual representations captures the force-applying entity while performing the sequence of actions. For instance, in a robotic control example, the force-applying entity can be a human hand, and the VLM input prompt can include video frames of the hand wiping a whiteboard along with EMG sensor data capturing the pressure applied by the hand against the board. As another example, in a computer application control setting, the VLM input prompt could include screen recordings of a user interacting with a graphical user interface and data from a force-sensitive touch-screen capturing interaction pressures during the interaction, such as distinguishing a light press from a firm press.

At block 504, the VLM input prompt is processed using a VLM to generate a final VLM output. Continuing the robot control example, the VLM processes the video frames and EMG data together in the single prompt to generate an output that describes the action of wiping, noting the specific times when pressure is applied. For instance, the final VLM output might be a natural language description such as, “move hand left, applying firm pressure; move hand right, applying firm pressure; lift hand, releasing pressure.” In the computer application example, the VLM processes the screen recording and screen pressure data to generate an output, such as text that might state, “user lightly selects ‘File’ menu, then firmly selects ‘Save As’ option,” linking the action to the force applied.

At block 506, based on the final VLM output, a robot or other system is caused to perform a sequence of actions that correspond to the sequence of actions captured in the visual representations. For the robot control example, the natural language output from block 504 can be used to generate a robot-executable script, such as a sequence of API calls that instruct a robot arm with an eraser to move across a surface while applying a specified force. For the computer application example, the VLM output could be used to generate a script that automates the described user interaction, such as executing a function call to open the ‘File’ menu and then another function call to trigger the ‘Save As’ dialog, thereby replicating the user's demonstrated workflow.

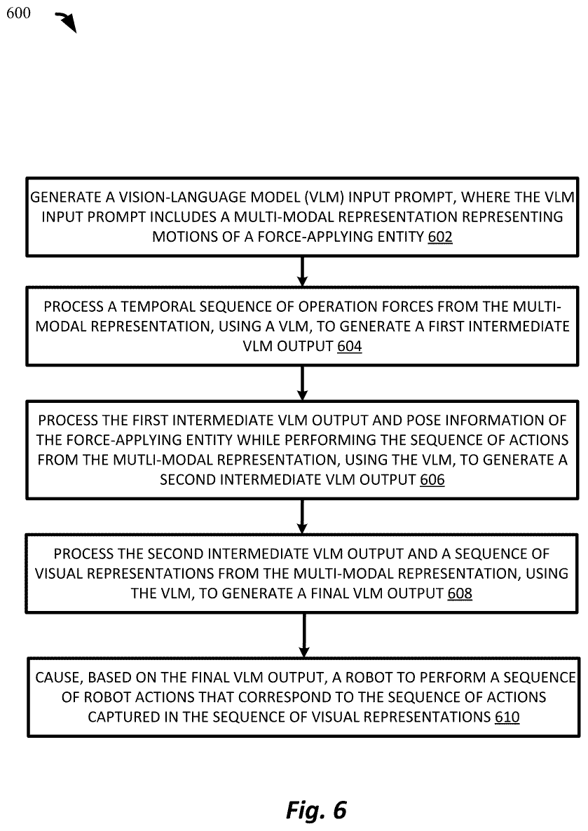

FIG. 6 is a flowchart illustrating an example process 600 for generating an action output based on iteratively processing multiple data modalities, in accordance with various implementations. The process 600 can be performed, for example, by one or more components of FIG. 1, such as the vision language system 130. Process 600 illustrates an example of a chain-of-modality framework.

At block 602, a VLM input prompt is generated that includes a multi-modal representation of motions of a force-applying entity.

At block 604, a temporal sequence of operation forces from the multi-modal representation is processed, using a VLM, to generate a first intermediate VLM output. In a robot control working example, a user may grasp a screwdriver to tighten a screw. An EMG sensor on the user's arm can capture the force data, which is then processed by a VLM. The first intermediate VLM output might be a textual description such as, “force applied at t=2 s, force released at t=5 s,” identifying key moments of force application. For a computer application control working example, a user might interact with a design application on a pressure-sensitive tablet. The pressure data captured while the user draws a firm line with a stylus can be processed. The first intermediate VLM output could be text stating, “high pressure detected from timestamp 10.1 to 11.5,” identifying the specific period of firm interaction.

At block 606, the first intermediate VLM output and pose information of the force-applying entity are processed, using the VLM, to generate a second intermediate VLM output. Continuing the robot control example, hand pose data captured from a video is combined with the force application timing from block 604. The VLM processes these two inputs to generate a second intermediate VLM output, such as, “at t=2 s, apply force and rotate clockwise.” This output connects the detected force with the corresponding motion (rotation). For the computer application example, pose information for the stylus (e.g., its angle and position) is processed with the pressure event data. The VLM could generate an output such as, “while high pressure is applied, stylus moves from coordinate (100,150) to (300,150),” linking the firm press action to a specific drawing motion.

At block 608, the second intermediate VLM output and a sequence of visual representations from the multi-modal representation are processed, using the VLM, to generate a final VLM output. In the robot control example, the video of the user turning the screwdriver is processed along with the intermediate output from block 606 (“apply force and rotate clockwise”). The VLM can now associate the action with the object in the video, producing a final output such as, “user applies force to grasp screwdriver handle and twists the screwdriver clockwise.” For the computer application example, the screen recording showing the design application is processed with the intermediate output (“high pressure applied, stylus moves from . . . ”). The final VLM output can add contextual information, such as, “user firmly draws a horizontal line in the main canvas window.”

At block 610, based on the final VLM output, a robot or other system is caused to perform a sequence of actions. For the robot control example, the final output is used to generate an executable script that instructs a robot arm with a screwdriver end-effector to grasp a target screwdriver and apply a rotational force to a screw. In the computer application control example, the final VLM output is used to generate an automation script. This script might call a drawing API function, such as draw Line (start_point, end_point, pressure=‘firm’), to replicate the user's drawing action within the application.

In some implementations, a method implemented by processor(s) is provided and includes obtaining vision data that visually captures an entity performing a sequence of actions related to one or more objects in an environment with the entity. The method further includes obtaining event data that captures non-visually detected events that occurred in the environment during performance of the sequence of actions by the entity. The method further includes generating an event data prompt that includes the event data and that excludes the vision data. The method further includes causing the event data prompt to be processed, using a vision-language model (VLM), to generate event data output that describes the non-visually detected events. The method further includes generating a vision data prompt that includes the vision data and that includes event content that is based on the event data output. The method further includes causing the vision data prompt to be processed, using the VLM, to generate vision data output that describes at least some of the non-visually detected events and the one or more objects. The method further includes generating an action prompt that includes the vision data output. The method further includes causing the action prompt to be processed to generate action output that reflects one or more automated actions to perform based on the sequence of actions and the non-visually detected events. The method further includes using the action output to cause implementation of the one or more automated actions.

These and other implementations of the technology disclosed herein can include one or more of the following features.

In some implementations, the method further includes obtaining pose data generated based on the vision data and/or based on additional vision data, generating a pose data prompt that includes the pose data and that includes initial event content that is based on the event data output, and causing the pose data prompt to be processed, using the VLM, to generate pose data output that describes the at least some of the non-visually detected events and one or more characteristics for each of the actions of the sequence of the actions. In those implementations, generating the vision data prompt includes: including the one or more characteristics, for each of the actions of the sequence of the actions, in the vision data prompt, based on the one or more characteristics being described in the pose data output; and including the at least some of the non-visually detected events based on them being described in the pose data output. In some versions of those implementations, the entity is a human and the pose data is for one or more hands of the human. In some of those or other versions, the pose data is represented by designated pixels determined to correspond to one or more parts of the entity. For example, the pose data can be a sequence of images with designated pixels of the images reflecting parts of the entity such as point(s) on a hand of a human entity.

In some implementations, the non-visually detected events are each a corresponding application of force by the entity. In some versions of those implementations, the entity is a human and the event data is detected by one or more sensors worn by the human during performing the sequence of actions. In some of those or other versions, wherein the one or more sensors include an electromyography (EMG) sensor.

In some implementations, the event data includes an image that reflects the non-visually detected events. In some of those implementations, the image includes a graph with a time axis and a magnitude axis that reflects corresponding magnitudes for the events. For example, the time axis can be an x-axis that reflects seconds or other measurement units and the magnitude axis can be a y-axis that reflects a magnitude of force or other magnitude.

In some implementations, the non-visually detected events are electrical events and/or acoustic events.

In some implementations, the one or more automated actions, reflected by the action output, are a sequence of robot actions that correspond to the sequence of actions and the non-visually detected events, and using the action output to cause implementation of the one or more automated actions includes causing a robot to perform a sequence of robot actions that correspond to the sequence of actions captured in the sequence of visual representations. In some versions of those implementations, the sequence of robot actions include one or more Python functions and/or one or more robot application programming interface (API) calls. In some of those or other versions, generating the action prompt further includes: including, in the action prompt, robot program content that describes a desired format of the sequence of robot actions and/or that includes one or more few shot examples of an example sequence of robot actions.

In some implementations, causing the action prompt to be processed to generate the action output comprises causing the action prompt to be processed using the VLM or using an alternative generative model.

In some implementations, the one or more automated actions, reflected by the action output, include one or more automated assistant actions, and using the action output to cause implementation of the one or more automated actions includes causing an automated assistant client device to initiate implementation of the one or more automated assistant actions. In some of those implementations, the one or more automated assistant actions include rendering visual and/or audible output via the automated assistant client device.

In some implementations, the method further includes generating a training instance that includes training instance input that includes the vision data and the event data, and training instance output that includes the vision data output or that includes the action output. In some of those implementations, the method further includes using the training instance to fine-tune the VLM or an alternative VLM.

In some implementations, the vision data output includes natural language content that describes the at least some of the non-visually detected events and the one or more objects. In some of those implementations, the vision data output consists of the natural language content.

In some implementations, the event data output further describes corresponding timestamps for the non-visually detected events.

In some implementations, the vision data output further describes at least some of the corresponding timestamps for the non-visually detected events.

In some implementations, a method implemented by processor(s) is provided and includes obtaining a sequence of operation forces applied by a force-applying entity while performing a sequence of actions with respect to an object, pose information of the force-applying entity, and a sequence of visual representations capturing the force-applying entity while performing the sequence of actions with respect to the object. The method further includes processing the sequence of operation forces, using a vision-language model (VLM), to generate a first intermediate VLM output. The method further includes processing the first intermediate VLM output and the pose information of the force-applying entity while performing the sequence of actions, using the VLM, to generate a second intermediate VLM output. The method further includes processing the second intermediate VLM output and the sequence of visual representations, using the VLM, to generate a final VLM output. The method further includes causing, based on the final VLM output, a robot to perform a sequence of robot actions that correspond to the sequence of actions captured in the sequence of visual representations.

In some implementations, a method implemented by processor(s) is provided and includes generating a vision-language model (VLM) input prompt that includes a sequence of operation forces applied by a force-applying entity while performing a sequence of actions with respect to an object, and a sequence of visual representations capturing the force-applying entity while performing the sequence of actions with respect to the object. The method further includes processing the VLM input prompt using a VLM to generate a final VLM output and causing, based on the final VLM output, a robot to perform a sequence of robot actions that correspond to the sequence of actions captured in the sequence of visual representations.

As a non-limiting example of some implementations disclosed herein, consider a scenario where a robotic system is configured to learn a task from a human demonstration. The task is to securely fasten a screw into a workpiece using a robotic manipulator arm equipped with a screwdriver end-effector.

Vision data is obtained. This vision data can be a video feed from a camera that visually captures a human operator performing the sequence of actions. For instance, the video shows the human picking up a screw, positioning the screw at a designated hole in a wooden block, picking up a screwdriver, aligning the screwdriver with the head of the screw, and then rotating the screwdriver multiple times to drive the screw into the block.

Concurrently, event data is also obtained. The human operator wears an armband with an electromyography (EMG) sensor that captures non-visually detected events. Specifically, the event data comprises a temporal series of force signals indicating when the operator applies rotational force (torque) with their arm and hand to turn the screwdriver. This force data is a non-visual modality, as the precise application of torque is not readily discernible from the video alone.

Next, an event data prompt is generated. This prompt includes only the event data, for example, a graphical representation of the EMG signal over time, and a textual instruction such as, “Describe the force application events in this data.” The event data prompt excludes the vision data (the video). This prompt is then caused to be processed by a vision-language model (VLM). The VLM generates event data output, which could be a textual description such as, “Force applied from t=5 s to t=7 s. Force released. Force applied from t=8 s to t=10 s. Force released. Force applied from t=11 s to t=13 s.”

Following this, a vision data prompt is generated. This new prompt includes the vision data (the video of the human operator) and also includes event content that is based on the previously generated event data output. For instance, the prompt might be structured as: “Given the video and the following event timings, describe the actions being performed on the objects. Events: Force applied at t=5-7 s, t=8-10 s, and t=11-13 s.”

This vision data prompt is then caused to be processed by the VLM. The VLM uses the video to identify the objects (screw, screwdriver, wooden block) and associates the actions with the event content. The resulting vision data output could be a more detailed, integrated description: “User positions screw on wooden block. User uses screwdriver to turn screw clockwise from t=5 s to t=7 s. User repositions screwdriver. User turns screw clockwise from t=8 s to t=10 s. User repositions screwdriver. User turns screw clockwise from t=11 s to t=13 s.” This output now accurately links the visual action of turning with the non-visual event of applying force.

An action prompt is then generated that includes this detailed vision data output. The action prompt can also include instructions for converting the description into robot-executable code, such as, “Generate Python code using the robot's API calls to replicate the described sequence.”

This action prompt is processed (e.g., by the VLM or another code-generation model) to generate action output. The action output is a sequence of one or more automated actions, such as a Python script with robot API calls: robot.move_to (screw_location), robot.grasp (screwdriver), robot.align (screw_head), robot.rotate_with_force (‘clockwise’, duration=2 s), robot.rotate_with_force (‘clockwise’, duration=2 s), and so on.

Finally, this action output is used to cause the implementation of the automated actions. The generated Python script is transmitted to the robotic manipulator arm, which then executes the sequence of API calls. The robot proceeds to pick up the screw and screwdriver, position them correctly, and apply rotational force at the appropriate times to drive the screw into the workpiece, thereby replicating the human's demonstrated task with an awareness of the necessary force application.

As another non-limiting example of implementations disclosed herein, consider a scenario where a human is preparing a meal. The system obtains vision data from a camera in a kitchen that visually captures the human performing a sequence of actions. For instance, the vision data shows the human retrieving a container of pre-marinated chicken from a refrigerator, placing the chicken on a baking sheet, and then placing the baking sheet into a smart oven. The system also obtains event data that captures non-visually detected events during this sequence. For example, the event data could be audio data from a microphone that captures the sound of the refrigerator door closing, and radio-frequency identification (RFID) data from an RFID reader that detects a tag on the chicken container, identifying its contents.

An event data prompt is generated that includes the audio and RFID data, but excludes the video. This event data prompt, which could be in the form of audio waveform representations and textual RFID readings, is processed by a vision-language model (VLM). The VLM generates event data output, such as the text: “refrigerator door closed at timestamp T1; RFID tag for ‘pre-marinated chicken’ detected at timestamp T2.”

Next, a vision data prompt is generated. This prompt includes the vision data (the video frames showing the human's actions) and event content based on the event data output, such as the text “Events detected: refrigerator door closed at T1, chicken identified at T2.” This vision data prompt is processed by the VLM to generate vision data output. The vision data output is a more comprehensive description that integrates the visual context with the non-visual events. For example, the vision data output could be: “Human takes chicken from refrigerator and places it into the smart oven at timestamp T3.”

Following this, an action prompt is generated that includes the vision data output. The action prompt could also include instructions such as “Based on the observed actions, generate automated home control actions to assist the user.” This action prompt is processed (e.g., by the VLM or another model) to generate action output. The action output might include a set of commands, such as oven.set_program(‘roast_chicken’) and oven.preheat(375 F).

Finally, this action output is used to cause the implementation of the automated actions. For example, the command oven.preheat(375 F) is transmitted to the smart oven, causing it to automatically begin preheating to the appropriate temperature for roasting chicken, thereby assisting the human by automating a subsequent step in the meal preparation process.

What is claimed is:

1. A method implemented using one or more processors, the method comprising
obtaining:
vision data that visually captures an entity performing a sequence of actions related to one or more objects in an environment with the entity; and
event data that captures non-visually detected events that occurred in the environment during performance of the sequence of actions by the entity;
generating an event data prompt that includes the event data and that excludes the vision data;
causing the event data prompt to be processed, using a vision-language model (VLM), to generate event data output that describes the non-visually detected events;
generating a vision data prompt that includes the vision data and that includes event content that is based on the event data output;
causing the vision data prompt to be processed, using the VLM, to generate vision data output that describes at least some of the non-visually detected events and the one or more objects;
generating an action prompt that includes the vision data output;
causing the action prompt to be processed to generate action output that reflects one or more automated actions to perform based on the sequence of actions and the non-visually detected events; and
using the action output to cause implementation of the one or more automated actions.

2. The method of claim 1, further comprising:
obtaining pose data generated based on the vision data and/or based on additional vision data;
generating a pose data prompt that includes the pose data and that includes initial event content that is based on the event data output; and
causing the pose data prompt to be processed, using the VLM, to generate pose data output that describes the at least some of the non-visually detected events and one or more characteristics for each of the actions of the sequence of the actions;
wherein generating the vision data prompt comprises:
including the one or more characteristics, for each of the actions of the sequence of the actions, in the vision data prompt, based on the one or more characteristics being described in the pose data output; and
including the at least some of the non-visually detected events based on them being described in the pose data output.

3. The method of claim 2, wherein the entity is a human and the pose data is for one or more hands of the human.

4. The method of claim 2, wherein the pose data is represented by designated pixels determined to correspond to one or more parts of the entity.

5. The method of claim 1, wherein the non-visually detected events are each a corresponding application of force by the entity.

6. The method of claim 5, wherein the entity is a human and the event data is detected by one or more sensors worn by the human during performing the sequence of actions.

7. The method of claim 6, wherein the one or more sensors include an electromyography (EMG) sensor.

8. The method of claim 1, wherein event data includes an image that reflects the non-visually detected events.

9. The method of claim 8, wherein the image includes a graph with a time axis and a magnitude axis that reflects corresponding magnitudes for the events.

10. The method of claim 1, wherein the non-visually detected events are acoustic events.

11. The method of claim 1,
wherein the one or more automated actions, reflected by the action output, are a sequence of robot actions that correspond to the sequence of actions and the non-visually detected events, and
wherein using the action output to cause implementation of the one or more automated actions includes causing a robot to perform a sequence of robot actions that correspond to the sequence of actions captured in the sequence of visual representations.

12. The method of claim 11, wherein generating the action prompt further comprises:
including, in the action prompt, robot program content that describes a desired format of the sequence of robot actions and/or that includes one or more few shot examples of an example sequence of robot actions.

13. The method of claim 1, wherein causing the action prompt to be processed to generate the action output comprises causing the action prompt to be processed using the VLM or using an alternative generative model.

14. The method of claim 1,
wherein the one or more automated actions, reflected by the action output, include one or more automated assistant actions, and
wherein using the action output to cause implementation of the one or more automated actions includes causing an automated assistant client device to initiate implementation of the one or more automated assistant actions.

15. The method of claim 1, further comprising:
generating a training instance that includes:
training instance input that includes the vision data and the event data, and
training instance output that includes the vision data output or that includes the action output; and
using the training instance to train the VLM or an alternative VLM.

16. The method of claim 1, wherein the vision data output includes natural language content that describes the at least some of the non-visually detected events and the one or more objects.

17. The method of claim 1, wherein the event data output further describes corresponding timestamps for the non-visually detected events.

18. The method of claim 17, wherein the vision data output further describes at least some of the corresponding timestamps for the non-visually detected events.

19. A method implemented using one or more processors, the method comprising
obtaining a sequence of operation forces applied by a force-applying entity while performing a sequence of actions with respect to an object, pose information of the force-applying entity, and a sequence of visual representations capturing the force-applying entity while performing the sequence of actions with respect to the object;
processing the sequence of operation forces, using a vision-language model (VLM), to generate a first intermediate VLM output;
processing the first intermediate VLM output and the pose information of the force-applying entity while performing the sequence of actions, using the VLM, to generate a second intermediate VLM output;
processing the second intermediate VLM output and the sequence of visual representations, using the VLM, to generate a final VLM output; and
causing, based on the final VLM output, a robot to perform a sequence of robot actions that correspond to the sequence of actions captured in the sequence of visual representations.

20. A method implemented using one or more processors, the method comprising
generating a vision-language model (VLM) input prompt that includes:
a sequence of operation forces applied by a force-applying entity while performing a sequence of actions with respect to an object, and
a sequence of visual representations capturing the force-applying entity while performing the sequence of actions with respect to the object;
processing the VLM input prompt using a VLM to generate a final VLM output; and
causing, based on the final VLM output, a robot to perform a sequence of robot actions that correspond to the sequence of actions captured in the sequence of visual representations.
